(19) United States
(12) Patent Application Publication
(10) Pub. No.: US 2026/0196542 A1
(43) Pub. Date: Jul. 9, 2026

(54) ADAPTIVE CONTROL SYSTEM FOR A VEHICLE

(71) Applicant: GM Global Technology Operations LLC, Detroit, MI (US)

(72) Inventors: Sumit Tripathi, Shelby Township, MI (US); Manish Sinha, St. Petersburg, FL (US); Sergio Eduardo Garcia, Commerce Township, MI (US); Joseph Berg, Highland, MI (US); David S. Thompson, Warren, MI (US)

(73) Assignee: GM Global Technology Operations LLC, Detroit, MI (US)

(21) Appl. No.: 19/013,304

(22) Filed: Jan. 8, 2025

(51) Int. Cl. H01M 8/04992; B60R 16/023; B60R 16/033; H01M 8/04537

(52) U.S. Cl. CPC H01M 8/04992; B60R 16/0231; B60R 16/033; H01M 8/04619; H01M 2250/20

(57) ABSTRACT

A computer-implemented method when executed by data processing hardware causes the data processing hardware to perform operations. The operations include estimating, via an adaptive algorithm, a balance of plant (BoP) power loss of a BoP of a fuel cell system (FCS), receiving, at the adaptive algorithm, an application power request, and executing, via the adaptive algorithm, a BoP degradation computation. The operations also include learning, via a plurality of sensors, a BoP loss error in the estimated BoP power loss based on a comparison with the BoP degradation computation, applying, based on the learned BoP loss error, an adaptation factor to the BoP degradation computation, and generating, via the adaptive algorithm, a stack power request based on the application power request and the estimated BoP power loss.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an adaptive control system.

Vehicles are equipped with various devices that utilize power at different rates. Such vehicles may be configured to output power of a device in response to a user input requesting a certain degree or level of power. However, the resultant power delivery may be inconsistent and may be inaccurate depending on an efficiency of the device and system. The vehicle utilizes internal equipment to supply reactants to a power stack to result in the proper reaction. However, some of the power from the power stack is typically diverted, at least in part, to the internal equipment. Thus, there is a need for an improved system for estimating the power consumed by the internal equipment and the amount of power to be delivered. This needed improvement would provide an improved method and system for estimating the power consumption in addition to the power output estimation.

### SUMMARY

In some aspects, a computer-implemented method when executed by data processing hardware causes the data processing hardware to perform operations. The operations include estimating, via an adaptive algorithm, a balance of plant (BoP) power loss of a BoP of a fuel cell system (FCS), receiving, at the adaptive algorithm, an application power request, and executing, via the adaptive algorithm, a BoP degradation computation. The operations also include learning, via a plurality of sensors, a BoP loss error in the estimated BoP power loss based on a comparison with the BoP degradation computation, applying, based on the learned BoP loss error, an adaptation factor to the BoP degradation computation, and generating, via the adaptive algorithm, a stack power request based on the application power request and the estimated BoP power loss.

In some examples, the operations may include characterizing, via the adaptive algorithm, a first phase of life of the BoP as a function of an operating parameter. Optionally, the operating parameter may include one or more of a direct current to direct current (DC-DC) converter ratio, a DC-DC converter input current, an FCS current, and an FCS output voltage. The operations may also include storing, at memory hardware, characteristic curves of an actual BoP power loss and retrieving, at a startup of the adaptive algorithm, the stored characteristic curves. In some instances, the operations may include comparing, via the adaptive algorithm, the characteristic curves and generating a measure of BoP degradation.

The operations may further include executing, via the adaptive algorithm, a reference model configured with an estimation function. The reference model may be a first principal model that may include an adaptable efficiency parameter. In some instances, estimating the BoP power loss may include executing the estimation function of the reference model. Optionally, generating the stack power request may include deploying an outer control loop. In some examples, generating the stack power request may include receiving the application power request from a fuel cell application. In further examples, generating the stack power request may include utilizing an FCS output voltage and the plurality of sensors.

In other aspects, an adaptive control system includes data processing hardware and memory hardware in communication with the data processing hardware. The memory hardware stores instructions that when executed on the data processing hardware cause the data processing hardware to perform operations. The operations include estimating, via an adaptive algorithm, a balance of plant (BoP) power loss of a BoP of a fuel cell system (FCS), receiving, at the adaptive algorithm, an application power request, and executing, via the adaptive algorithm, a BoP degradation computation. The operations also include learning, via a plurality of sensors, a BoP loss error in the estimated BoP power loss based on a comparison with the BoP degradation computation, applying, based on the learned BoP loss error, an adaptation factor to the BoP degradation computation, and generating, via the adaptive algorithm, a stack power request based on the application power request and the estimated BoP power loss.

In some examples, the operations may include characterizing, via the adaptive algorithm, a first phase of life of the estimated BoP power loss as a function of an operating parameter. Optionally, the operating parameter includes one or more of a DC-DC converter ratio, a DC-DC converter input current, an FCS current, and an FCS output voltage. The operations may also include storing, at the memory hardware, characteristic curves of an actual BoP power loss. The characteristic curves may include an initial learning curve and a slow learning curve. The operations may further include comparing, via the adaptive algorithm, the characteristic curves and generating a measure of BoP degradation. In further examples, the operations may include executing, via the adaptive algorithm, a reference model configured with an estimation function.

In further aspects, an adaptive control system for a vehicle includes data processing hardware and memory hardware in communication with the data processing hardware. The memory hardware stores instructions that when executed on the data processing hardware cause the data processing hardware to perform operations. The operations include executing, via an adaptive algorithm, a reference model configured with an estimation function, estimating, via the estimation function, a balance of plant (BoP) power loss of a BoP of a fuel cell system (FCS) of the vehicle, receiving, at the adaptive algorithm, an application power request, and executing, via the adaptive algorithm, a BoP degradation computation. The operations also include learning, via sensor data from a plurality of sensors, a BoP loss error in the estimated BoP power loss based on a comparison with the BoP degradation computation, applying, based on the learned BoP loss error, an adaptation factor to the BoP degradation computation, generating, via the adaptive algorithm, an adapted stack power request based on the application power request and the estimated BoP power loss, and storing, at the memory hardware, characteristic curves of an actual BoP power loss.

In some examples, generating the adapted stack power request may include deploying an outer control loop. In some instances, generating the adapted stack power request may include receiving the application power request from a fuel cell application. Optionally, generating the adapted stack power request may include utilizing an FCS output voltage and the plurality of sensors.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with an adaptive control system according to the present disclosure;

FIG. 2 is an exemplary block diagram of an adaptive control system according to the present disclosure;

FIG. 3 is a schematic diagram of a power circuit of an adaptive control system according to the present disclosure;

FIG. 4 is an example flow diagram for an adaptive control system according to the present disclosure;

FIG. 5 is another example flow diagram for an adaptive control system according to the present disclosure; and

FIG. 6 is an exemplary flow diagram for a method of executing an adaptive control system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM) / erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

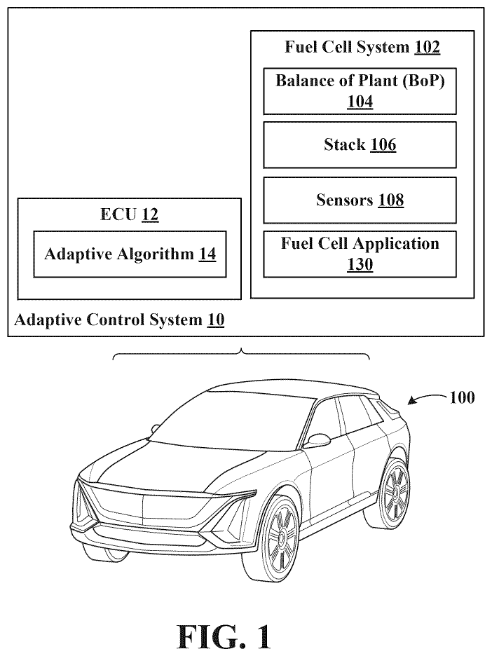

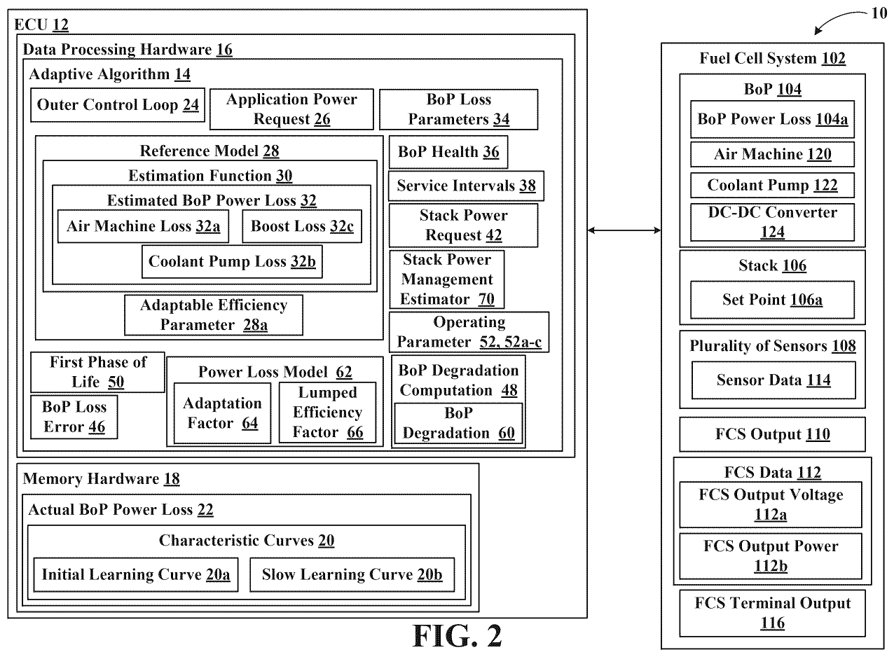

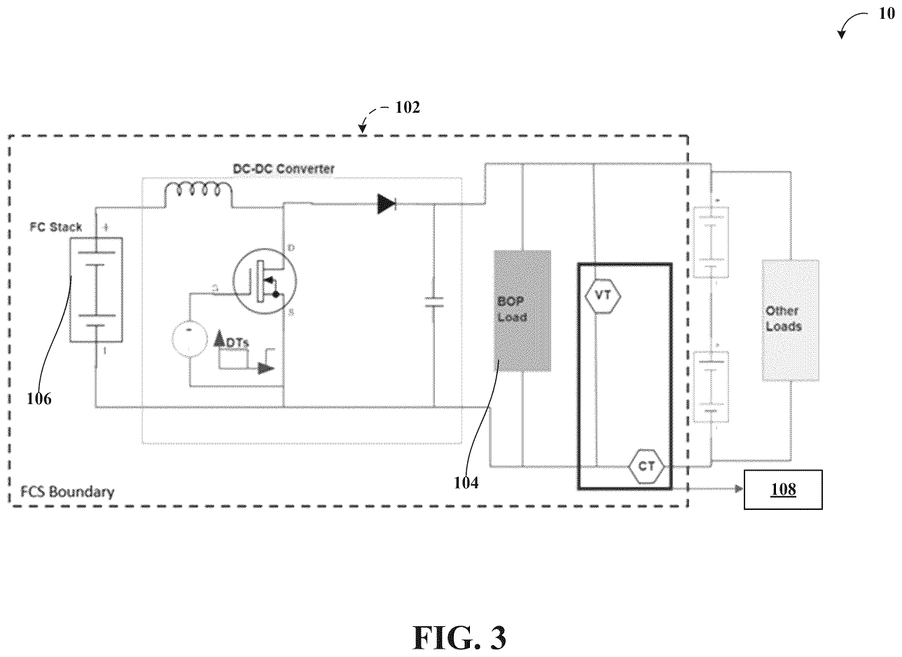

Referring to FIGS. 1-3, an adaptive control system 10 is configured for a vehicle 100 equipped with a fuel cell system 102. The adaptive control system 10 is also configured for other machinery including, but not limited to, industrial machines, power generation units, transportation machines, aircrafts, marine machinery, and any other mechanical-based machinery that may benefit from the adaptive control system 10. The fuel cell system 102 includes a balance of plant (BoP) 104, a stack 106, and a plurality of sensors 108. The BoP 104 is configured to provide reactants to the stack 106 to provide a reaction that generates power at the fuel cell system 102. The BoP 104 may utilize, at least in part, some of the generated power, which is categorized as a BoP power loss 104a, described herein. The remainder of the generated power is output as a fuel cell system (FCS) output 110. The plurality of sensors 108 may include, but are not limited to, a current sensor 108a and a voltage sensor 108b. The adaptive control system 10 is configured to selectively adapt the fuel cell system (FCS) output 110 by analyzing FCS data 112 to accommodate and nullify the BoP power loss 104a. The FCS data 112 may include FCS output voltage 112a and FCS output power 112b, described in more detail below.

The adaptive control system 10 also includes an electronic control unit (ECU) 12 equipped at the vehicle 100. The ECU 12 is configured with an adaptive algorithm 14 that is executed by data processing hardware 16 of the ECU 12. The data processing hardware 16 is in communication with memory hardware 18. The memory hardware 18 stores instructions that, when executed by the data processing hardware 16, cause the data processing hardware 16 to perform operations, described herein. The memory hardware 18 may be an internal or external flash memory that may be utilized by the adaptive control system 10 to store characteristic curves 20 of an actual BoP power loss 22, described in more detail below. The characteristic curves 20 may include an initial learning curve 20a and a slow learning curve 20b. The characteristic curves 20 may be retrieved from the memory hardware 18 at a startup of the adaptive algorithm 14. The adaptive algorithm 14 is also configured to deploy an outer control loop 24, described below, at the fuel cell system 102 in response to an application power request 26. Initially, the adaptive algorithm 14 receives the application power request 26 from, for example, a user input or user activation of a device of the vehicle 100. The adaptive algorithm 14 may generate the stack power request 42 based on the application power request 26 and the estimated BoP power loss 32.

With further reference to FIGS. 1-3, the adaptive algorithm 14 is configured to execute a reference model 28 configured with an estimation function 30 to estimate a BoP power loss 32. The reference model 28 is a first principal model that includes an adaptable efficiency parameter 28a. The BoP power loss 32 may include an air machine loss 32a, coolant pump loss 32b, and boost power loss 32c. The adaptive algorithm 14 is also configured to identify BoP loss parameters 34 by receiving sensor data 114 from the plurality of sensors 108. For example, the current sensor 108a is disposed at an FCS terminal output 116 to capture the FCS output 110 and identify the BoP loss parameters 34, which are communicated to the adaptive algorithm 14 as part of the sensor data 114. The current sensor 108a captures a current and the voltage sensor 108b captures voltage, and the current and voltage are multiplied together to define the power that is the FCS output 110. As described herein, the adaptive algorithm 14 is configured to learn the BoP loss parameters 34 to, ultimately, identify the actual BoP power loss 22. The actual BoP power loss 22 is defined by the difference between the power generated by the stack 106 and the power delivered as the FCS output 110. The actual BoP power loss 22 may be stored in the memory hardware 18, such that the adaptive algorithm 14 may utilize the actual BoP power loss 22 in future iterations to ensure that the efficiency of the fuel cell system 102 is maintained.

The adaptive algorithm 14 may also utilize the BoP loss parameters 34 to predict or otherwise identify a BoP health 36. The BoP health 36 may predict service intervals 38 for the fuel cell system 102. For example, the BoP health 36 may provide information related to the health of an air machine 120, a coolant pump 122, and a direct current to direct current (DC-DC) converter 124 of the fuel cell system 102. The adaptive algorithm 14 may, thus, analyze the BoP health 36 to identify the service intervals 38 for the fuel cell system 102.

During operation of the fuel cell system 102, the outer control loop 24 is deployed by the adaptive algorithm 14 to convert the application power request 26 from a fuel cell application 130 of the fuel cell system 102 to an adapted stack power request 42. For example, the adapted stack power request 42 is generated via the adaptive algorithm 14 based on the application power request 26 and the estimated BoP power loss 32. The fuel cell application 130 may generally correspond to a device coupled with or otherwise part of the fuel cell system 102, which may be triggered by a user input or the application power request 26. The adaptive algorithm 14 may be configured to initiate or execute the outer control loop 24 by managing the application power request 26 and generating the stack power request 42. The adaptive algorithm 14 utilizes the FCS output voltage 112a and the sensors 108 to execute the outer control loop 24. The adaptive algorithm 14 executes a two-step approach to convert the application power request 26 to the stack power request 42, described herein.

In response to the application power request 26, mentioned above, the adaptive algorithm 14 utilizes the sensor data 114 from the sensors 108 to learn a BoP loss error 46 of the estimated BoP power loss 32 using a BoP degradation computation 48. The BoP loss error 46 is determined by the sensor data 114 reflecting the actual BoP power loss 22 by capturing the power generated by the stack 106 and the power delivered as the FCS output 110. The adaptive algorithm 14 then calculates the difference between the power generated by the stack 106 and the power delivered as the FCS output 110 to identify the actual BoP power loss 22 and, thus, the BoP loss error 46.

For example, the adaptive algorithm 14 compares the estimated BoP power loss 32 with the actual BoP power loss 22 to determine the BoP loss error 46 using the BoP degradation computation 48, as mentioned above. The adaptive algorithm 14 utilizes the BoP degradation computation 48 to characterize a first phase of life 50 of the BoP 104 as a function of an operating parameter 52. The operating parameter 52 may include, but is not limited to, a direct current to direct current (DC-DC) converter ratio 52a, a DC-DC converter input current 52b, an FCS current 52c, and the FCS output voltage 112a. The adaptive algorithm 14 compares the characteristic curves 20 of the actual BoP power loss 22 to generate a measure of BoP degradation 60 via the BoP degradation computation 48.

The measure of BoP degradation 60 is utilized by a power loss model 62 of the adaptive algorithm 14. As mentioned above, the estimated BoP power loss 32 includes the air machine loss 32a, the coolant pump loss 32b, and the boost power loss 32c. Similarly, the BoP degradation 60 may include compressor degradation 60a, coolant pump degradation 60b, and boost power degradation 60c. For example, the power loss model 62 may assess the air flow, temperature, and delta pressure for the air machine 120. The power loss model 62 may then calculate how much power the air machine 120 needs relative to the estimated air machine loss 32a and the identified compressor degradation 60a. The power loss model 62 provides collective inefficiencies (i.e., BoP degradation 60 and actual BoP power loss 22) of the BoP 104, which includes the air machine 120, the coolant pump 122, and the DC-DC converter 124. For example, the power loss model 62 may provide an adaptation factor 64, which may be used to correct for the collective inefficiencies of the BoP 104.

As mentioned above, the estimated BoP power loss 32 may be different from the actual BoP power loss 22. The estimated BoP power loss 32 may also be different from the calculated BoP degradation 60, which further verifies or confirms the BoP loss error 46. Based on the BoP degradation computation 48, the adaptive algorithm 14 may apply a correction to the estimated BoP power loss 32. For example, the BoP loss error 46 may be integrated with the operating parameters 52 to define an adaptation factor 64. The adaptation factor 64 provides a lumped efficiency factor 66 of the BoP 104. The adaptive algorithm 14 applies the adaptation to the estimated BoP power loss 32 identified using the BoP degradation computation 48 to generate the lumped efficiency factor 66.

The lumped efficiency factor 66 is a characteristic of the fuel cell system 102, such that the lumped efficiency factor 66 is maintained regardless of operating conditions of the fuel cell system 102. The adaptive algorithm 14 is configured to learn the lumped efficiency factor 66 and utilize the lumped efficiency factor 66 for future operation monitoring of the fuel cell system 102. The power loss model 62 is executed for each component of the BoP 104 (i.e., the air machine 120, the coolant pump 122, and the DC-DC converter 124), such that each component of the BoP 104 may have a corresponding lumped efficiency factor 66. If any additional components are added to the fuel cell system 102, then the adaptive algorithm 14 is configured to execute the power loss model 62 for each new component to identify a respective lumped efficiency factor 66. Thus, the adaptive algorithm 14, and the fuel cell system 102 as a result, is adjustable or adaptable if more fuel cell drain sinks are added to the fuel cell system 102 to improve the power quality and accuracy of power delivered.

The adaptive algorithm 14 is also configured to isolate or otherwise separate each of the components of the BoP 104. For example, if the adaptive algorithm 14 identifies that the air machine 120 is operating and is determining the efficiency associated with the air machine 120, then the adaptive algorithm 14 may isolate the sensor data 114 associated with the air machine 120 as compared to the coolant pump 122 and the DC-DC converter 124. In another example, if the coolant pump 122 is the component being isolated, then the adaptive algorithm 14 may determine the lumped efficiency factor 66b of the coolant pump 122 while the air machine 120 is idle or otherwise inactive. Thus, the adaptive algorithm 14 can identify independent lumped efficiency factors 66 for each component in isolation. As a result, the adaptation factor 64 may also be independently identified (i.e., identified in isolation) for each component of the BoP 104 so that the lumped efficiency factor 66 for the isolated component may be utilized during adaptation.

With further reference to FIGS. 1-3, the lumped efficiency factor 66 is used in combination with the estimated BoP loss 32 to identify the FCS output power 112b. For example, the estimated BoP loss 32 is divided by the lumped efficiency factor 66 to produce the power required by the stack 106. Based on the calculation, the adaptive algorithm 14 may communicate with the fuel cell system 102 to adjust a set point 106a of the stack 106 to deliver power that correlates with the initial application power request 26. Thus, the lumped efficiency factor 66 is utilized by the adaptive algorithm 14 to adjust the amount of power that is output by the stack 106 to accommodate for the actual BoP power loss 22, which is otherwise redirected back to the BoP 104.

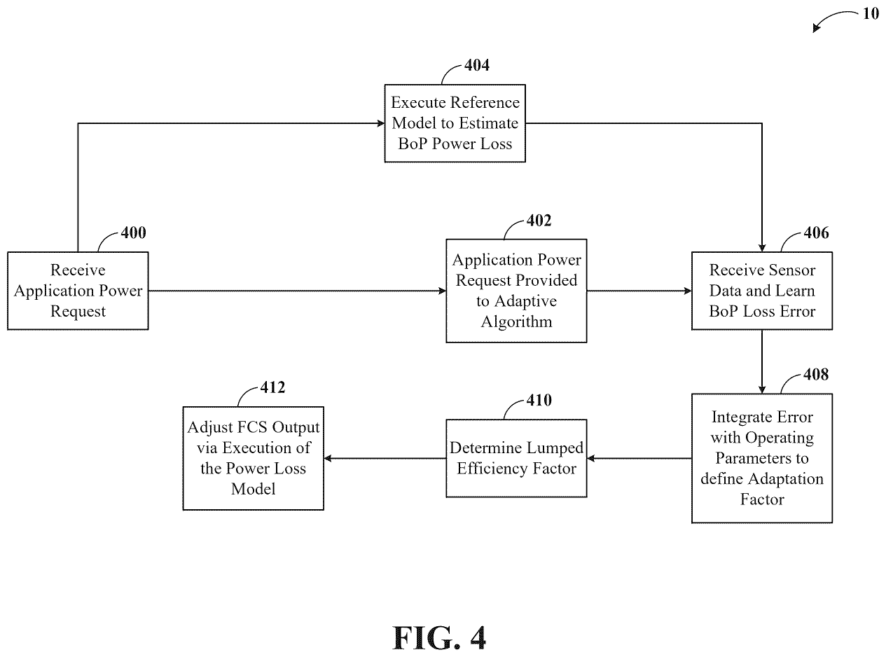

Referring now to FIG. 4, an exemplary flow diagram of the adaptive control system 10 is illustrated. At 400, the application power request 26 is received and, at 402, the application power request 26 is provided to the adaptive algorithm 14. In response to the application power request 26, the adaptive algorithm 14 executes, 404, a reference model 28 that may be utilized to estimate the BoP power loss 32. The adaptive algorithm 14 receives, at 406, sensor data 114 from the sensors 108, which is used to learn a BoP loss error 46 of the estimated BoP power loss 32. The BoP loss error 46 is integrated, at 408, with the operating parameters 52 to define the adaptation factor 64. Based on the adaptation factor 64, the adaptive algorithm 14 determines, at 410, the lumped efficiency factor 66. Through execution of the power loss model 62, the adaptive algorithm 14 adjusts, at 412, the FCS output 110 to accommodate for the inefficiencies of the BoP 104.

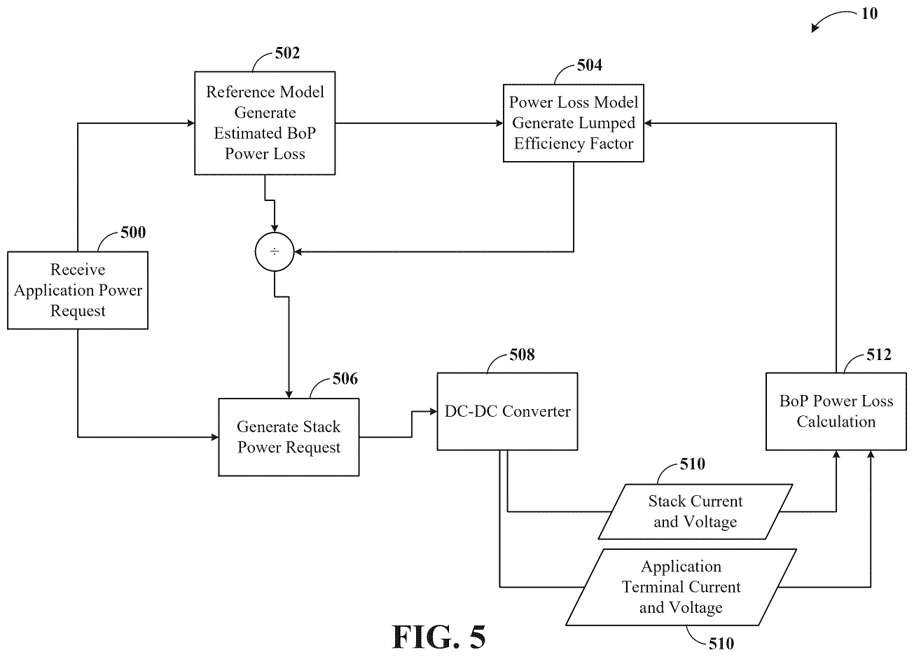

With reference now to FIG. 5, an exemplary flow diagram of the adaptive control system 10 is illustrated. At 500, the application power request 26 is received and provided, at 502, to the reference model 28 that is configured to communicate with a stack power management estimator 70. The reference model 28 is configured to generate the estimated BoP power loss 32. At 504, the power loss model 62 generates the lumped efficiency factor 66, which is utilized with the estimated BoP power loss 32 from the reference model 28 and the application power request 26 to generate the stack power request 42, at 506. For example, the stack power request 42 is equal to the application power request 26 added to the product of the estimated BoP power loss 32 divided by the lumped efficiency factor 66. The stack power request 42 is provided to a DC-DC converter 124, at 508, and the DC-DC converter 124 provides, at 510, stack current and voltage and application terminal current and voltage to a BoP power loss calculation. The BoP power loss calculation is executed, at 512, and provided to the power loss model 62.

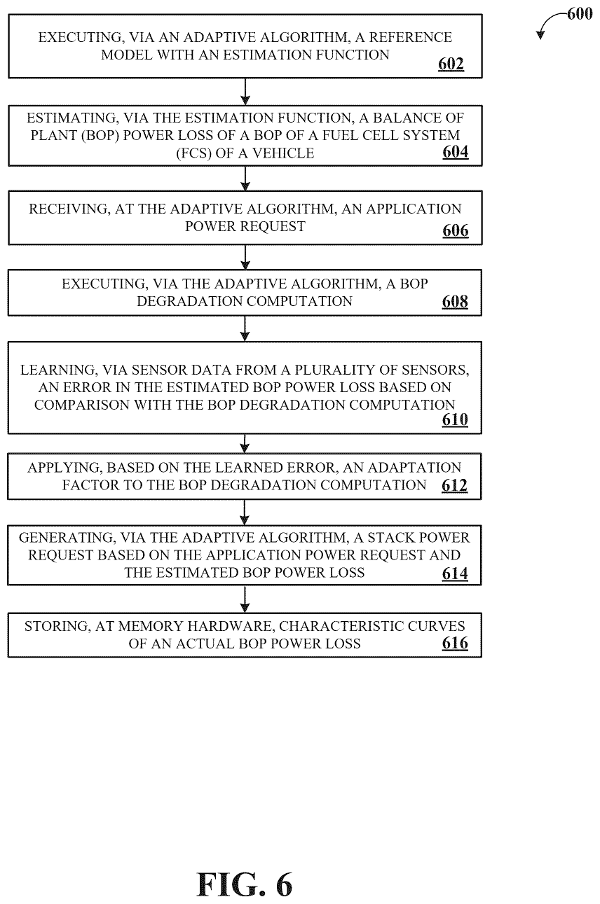

Referring now to FIG. 6, an exemplary method 600 for executing or operating the adaptive control system 10 is illustrated. At 602, an adaptive algorithm 14 estimates a balance of plant (BoP) power loss 32 of a BoP 104 of a fuel cell system (FCS) 102 of the vehicle 100. The adaptive algorithm 14 executes, at 604, a reference model 28. The reference model 28 is configured with an estimation function 30 to estimate a BoP power loss 32. The adaptive algorithm 14 receives, at 606, an application power request 26. At 608, the adaptive algorithm 14 executes a BoP degradation computation 48 and learns, at 610, a BoP loss error 46, via a plurality of sensors 108, in the estimated BoP power loss 32 based on a comparison with the BoP degradation computation 48. Based on the learned BoP loss error 46, the adaptive algorithm 14 applies, at 612, a correction to the BoP degradation computation 48 and generates, at 614, an adapted stack power request 40 based on the application power request 26 and the estimated BoP power loss 32. At 616, characteristic curves 20 of an actual BoP power loss 22 are stored at the memory hardware 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
estimating, via an adaptive algorithm, a balance of plant (BoP) power loss of a BoP of a fuel cell system (FCS);
receiving, at the adaptive algorithm, an application power request;
executing, via the adaptive algorithm, a BoP degradation computation;
learning, via a plurality of sensors, a BoP loss error in the estimated BoP power loss based on a comparison with the BoP degradation computation;
applying, based on the learned BoP loss error, an adaptation factor to the BoP degradation computation; and
generating, via the adaptive algorithm, a stack power request based on the application power request and the estimated BoP power loss.

2. The method of claim 1, further including characterizing, via the adaptive algorithm, a first phase of life of the BoP as a function of an operating parameter.

3. The method of claim 2, wherein the operating parameter includes one or more of a direct current to direct current (DC-DC) converter ratio, a DC-DC converter input current, an FCS current, and an FCS output voltage.

4. The method of claim 1, further including storing, at memory hardware, characteristic curves of an actual BoP power loss and retrieving, at a startup of the adaptive algorithm, the stored characteristic curves.

5. The method of claim 4, further including comparing, via the adaptive algorithm, the characteristic curves and generating a measure of BoP degradation.

6. The method of claim 1, further including executing, via the adaptive algorithm, a reference model configured with an estimation function, the reference model being a first principal model including an adaptable efficiency parameter.

7. The method of claim 6, wherein estimating the BoP power loss includes executing the estimation function of the reference model.

8. The method of claim 1, wherein generating the stack power request includes deploying an outer control loop.

9. The method of claim 1, wherein generating the stack power request includes receiving the application power request from a fuel cell application.

10. The method of claim 1, wherein generating the stack power request includes utilizing an FCS output voltage and the plurality of sensors.

11. An adaptive control system comprising:
data processing hardware; and
memory hardware in communication with the data processing hardware, the memory hardware storing instructions that when executed on the data processing hardware cause the data processing hardware to perform operations comprising:
estimating, via an adaptive algorithm, a balance of plant (BoP) power loss of a BoP of a fuel cell system (FCS);
receiving, at the adaptive algorithm, an application power request;
executing, via the adaptive algorithm, a BoP degradation computation;
learning, via a plurality of sensors, a BoP loss error in the estimated BoP power loss based on a comparison with the BoP degradation computation;
applying, based on the learned BoP loss error, an adaptation factor to the BoP degradation computation; and
generating, via the adaptive algorithm, a stack power request based on the application power request and the estimated BoP power loss.

12. The adaptive control system of claim 11, further including characterizing, via the adaptive algorithm, a first phase of life of the estimated BoP power loss as a function of an operating parameter.

13. The adaptive control system of claim 12, wherein the operating parameter includes one or more of a DC-DC converter ratio, a DC-DC converter input current, an FCS current, and an FCS output voltage.

14. The adaptive control system of claim 11, further including storing, at the memory hardware, characteristic curves of an actual BoP power loss, the characteristic curves including an initial learning curve and a slow learning curve.

15. The adaptive control system of claim 14, further including comparing, via the adaptive algorithm, the characteristic curves and generating a measure of BoP degradation.

16. The adaptive control system of claim 11, further including executing, via the adaptive algorithm, a reference model configured with an estimation function.

17. An adaptive control system for a vehicle, the adaptive control system comprising:
data processing hardware; and
memory hardware in communication with the data processing hardware, the memory hardware storing instructions that when executed on the data processing hardware cause the data processing hardware to perform operations comprising:
executing, via an adaptive algorithm, a reference model configured with an estimation function;
estimating, via the estimation function, a balance of plant (BoP) power loss of a BoP of a fuel cell system (FCS) of the vehicle;
receiving, at the adaptive algorithm, an application power request;
executing, via the adaptive algorithm, a BoP degradation computation;
learning, via sensor data from a plurality of sensors, a BoP loss error in the estimated BoP power loss based on a comparison with the BoP degradation computation;
applying, based on the learned BoP loss error, an adaptation factor to the BoP degradation computation;
generating, via the adaptive algorithm, an adapted stack power request based on the application power request and the estimated BoP power loss; and
storing, at the memory hardware, characteristic curves of an actual BoP power loss.

18. The adaptive control system of claim 17, wherein generating the adapted stack power request includes deploying an outer control loop.

19. The adaptive control system of claim 17, wherein generating the adapted stack power request includes receiving the application power request from a fuel cell application.

20. The adaptive control system of claim 17, wherein generating the adapted stack power request includes utilizing an FCS output voltage and the plurality of sensors.
